(19) United States
(12) Patent Application Publication
(10) Pub. No.: US 2025/0178581 A1
(43) Pub. Date: Jun. 5, 2025

(54) CLAMPING FORCE ESTIMATION

(71) Applicant: ZF Active Safety US Inc., Livonia, MI (US)

(72) Inventors: Yuhong Zheng, Ann Arbor, MI (US); Jeff E. Shaya, Birmingham, MI (US)

(21) Appl. No.: 18/526,041

(22) Filed: Dec. 1, 2023

(51) Int. Cl. B60T 17/22; G01L 5/00

(52) U.S. Cl. CPC B60T 17/221; G01L 5/0038

(57) ABSTRACT

Systems and methods for clamping force estimation are provided. In one example, operations include generating a displacement-torque curve based on displacement data and motor torque data of an electric motor of the EMB system for a braking episode having a switchover time. The operations also include determining a high torque value and a low torque value at the switchover time from the displacement-torque curve. The operations further include calculating a friction coefficient based on the high torque value and the low torque value. The operations yet further include determining a non-linear coefficient from the displacement-torque curve. The operations include estimating a clamping force for a constant speed based on the friction coefficient and the non-linear coefficient.

### TECHNICAL FIELD

This description relates to estimating clamping force based on motor torque hysteresis without use of a clamping force sensor.

### BACKGROUND

Braking systems are used for decelerating or stopping a running vehicle and maintaining a parked state. For example, a conventional disc brake uses a caliper operated with hydraulic fluid (e.g., brake oil). However, increasingly electromechanical brakes (EMBs), with an electric motor or actuator, are used to apply the braking force, instead of hydraulic pressure. In a disc brake embodiment, stators and rotating discs are axially enclosed by two outer discs. To cause the rotating discs to slow down or stop rotating (i.e., brake), a clamping force is applied to at least one of the outer discs, forcing the outer discs, the stators and the rotating discs together. In particular, the motor converts electrical energy into mechanical energy that causes the clamping force to be applied to the outer disc. When the rotating discs are forced together, friction reduces the angular speed of the rotating discs.

### SUMMARY

A first example relates to a non-transitory machine-readable medium having machine executable instructions for clamping force estimation that causes a processor core to execute operations. The operations include generating a displacement-torque curve based on displacement data and motor torque data of an electric motor of the EMB system for a braking episode having a switchover time. The operations also include determining a high torque value and a low torque value at the switchover time from the displacement-torque curve. The operations further include calculating a friction coefficient based on the high torque value and the low torque value. The operations yet further include determining a non-linear coefficient from the displacement-torque curve. The operations include estimating a clamping force for a constant speed based on the friction coefficient and the non-linear coefficient.

A second example relates to a clamping force estimation system that includes a memory for storing machine-readable instructions and a processor core. The processor core accesses the machine-readable instructions and executes the machine-readable instructions as operations. The operations include generating a displacement-torque curve based on displacement data and motor torque data of an electric motor of the EMB system for a braking episode having a switchover time. The operations also include determining a high torque value and a low torque value at the switchover time from the displacement-torque curve. The operations further include calculating a friction coefficient based on the high torque value and the low torque value. The operations yet further include determining a non-linear coefficient from the displacement-torque curve. The operations include estimating a clamping force for a constant speed based on the friction coefficient and the non-linear coefficient.

A third example relates to a method for clamping force estimation. The method includes generating a displacement-torque curve based on displacement data and motor torque data of an electric motor of the EMB system for a braking episode having a switchover time. The method also includes determining a high torque value and a low torque value at the switchover time from the displacement-torque curve. The method further includes calculating a friction coefficient based on the high torque value and the low torque value. The method yet further includes determining a non-linear coefficient from the displacement-torque curve. The method includes estimating a clamping force for a constant speed based on the friction coefficient and the non-linear coefficient.

### BRIEF DESCRIPTION OF THE DRAWINGS

FIG. 1 illustrates an example of an operating environment for a clamping force estimation system.

FIG. 2 illustrates an example of a physical environment of an electromechanical braking (EMB) system associated with the clamping force estimation system.

FIG. 3 illustrates a flowchart of an example method for estimating claiming force with a clamping force estimation system.

FIG. 4 illustrates an example displacement-torque curve generated by a clamping force estimation system.

FIG. 5 illustrates an example of curve fitting for the example displacement-torque curve.

### DETAILED DESCRIPTION

An electric brake of an electromechanical braking (EMB) system is controlled with a clamping force which is the braking force. In the EMB system, a force sensor capable of measuring the clamping force is used to control the clamping. Because the brake force of the driver is not directly used as the braking force but is braked by the clamping force of the electric motor, the EMB system utilizes a force sensor to determine the clamping force corresponding to the desired braking force. The force sensor is generally mounted in a caliper with a spindle (screw/nut) and is configured to be a ring type because the spindle must penetrate when sensing the clamping force. However, the addition of the force sensor, increases cost and complexity of the EMB system.

For example, a conventional force sensor may be a strain gauge type having the shape of a ring and serving as a load cell. The caliper body of the conventional braking system is deformed by the clamping force when the electric brake is employed. Therefore, it is difficult to guarantee the accuracy of the force sensor. Accordingly, the cost of the force sensor and the technical difficulty to design and implement the force sensor are increased.

To reduce cost and complexity, the systems and methods described herein estimate the clamping force without a force sensor. Instead, the clamping force is estimated based on a model that determines clamping force versus motor torque hysteresis given displacement data and motor currents. Because there are part-to-part variations and run-to-run variations in clamping force, it is difficult to decouple motor torque hysteresis from displacement hysteresis. This is further complicated by noisy motor torque signals. The model provided herein generates a displacement-torque curve based on displacement data and motor torque data of the EMB system for a braking episode having a switchover time. A high torque value and a low torque value are determined at the switchover time from the displacement-torque curve because the displacement hysteresis goes to zero at the switchover time. Accordingly, the systems and methods described herein are able to isolate the motor torque hysteresis.

A friction coefficient is calculated for the model based on the high torque value and the low torque value. The friction coefficient is indicative of the unit efficiency specific to the hardware of the EMB system. A non-linear coefficient is also calculated that represents non-linearity parameters, such as misalignment of components of the hardware of the EMB system, that result in a non-linear relationship between torque and force. The clamping force is estimated based on the friction coefficient and a non-linear coefficient. Therefore, the motor torque hysteresis is decoupled from displacement hysteresis and the clamping force is estimated based on a friction coefficient and non-linear coefficient that are tailored to the efficiency of the hardware of the EMB system. Accordingly, the clamping force estimation estimates clamping force in real-time that is tailored to the individual components of the EMB system without adding additional components, such as a force sensor.

### I. System Overview

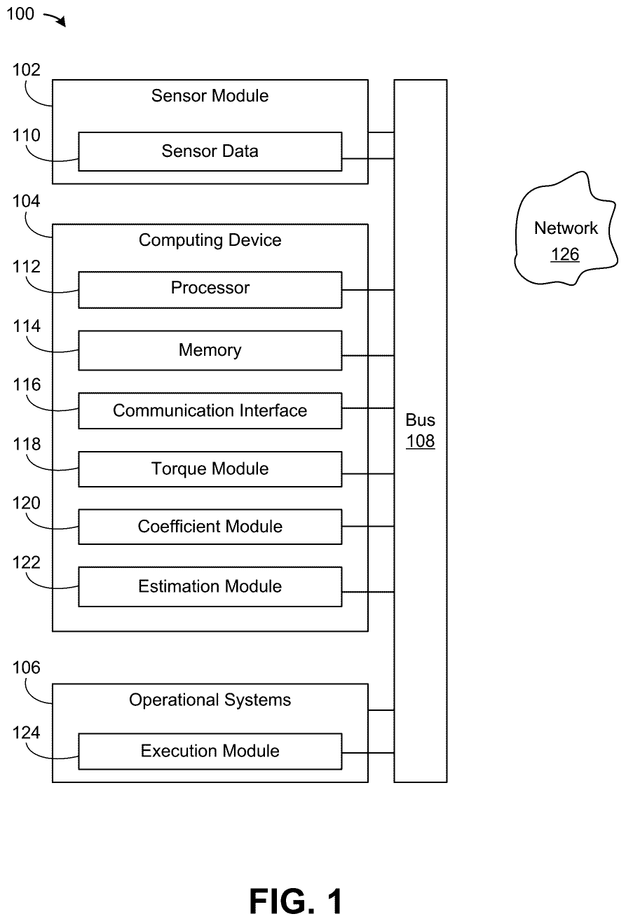

FIG. 1 illustrates an example operating environment of a clamping force estimation system 100. The components of the clamping force estimation system 100, as well as the components of other systems, hardware architectures, and software architectures discussed herein, can be combined, omitted, or organized into different architectures for various embodiments. For example, the clamping force estimation system 100 may represent an application software executing on a computing platform of the operating environment. The clamping force estimation system 100 includes a sensor module 102, a computing device 104, and an operational system 106 interconnected by a bus 108.

The sensor module 102 receives sensor data 110 associated with an EMB system. For clarity, components will be described with respect to vehicular examples, as a vehicle component of a vehicle. A vehicle is a moving machine that traverses a physical environment and is powered by any form of energy. The vehicle may be a spacecraft, aircraft, watercraft, submarine, car, truck, van, minivan, sport utility vehicle, motorcycle, scooter, amusement ride car, etc. The vehicle may include vehicles that are automated or non-automated with predetermined paths or be free moving.

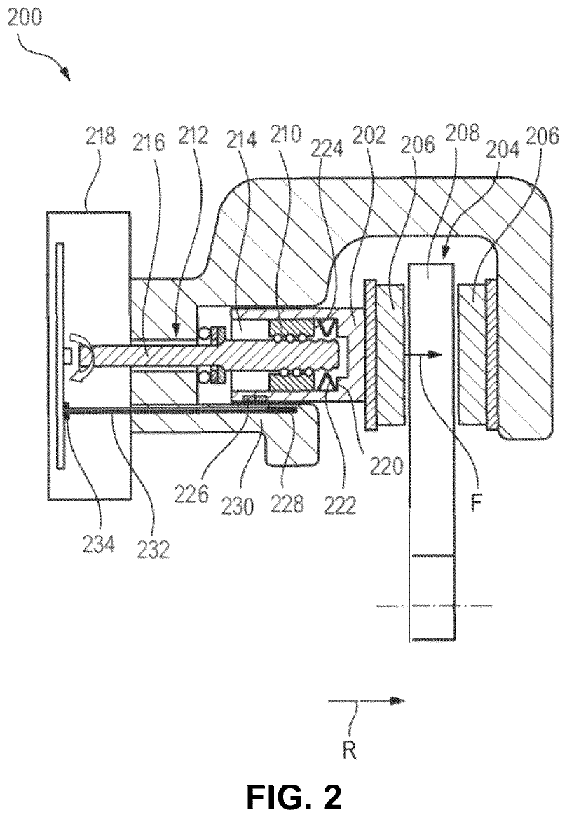

Turning to FIG. 2, in one example, an EMB system 200 of a vehicle includes an actuation piston 202 which acts on a braking assembly 204 and transfers thereto a braking force F. The braking assembly 204 here is a known floating brake caliper with two brake pads 206 and a brake disc 208 arranged between them. A ball screw nut 210 of a ball screw drive 212 is received in an inner cavity 214 of the actuation piston 202. A spindle 216 of the ball screw drive 212 is coupled to an electric motor 218, which can set the spindle 216 in rotation, which moves the ball screw nut 210 linearly along the spindle 216. If the ball screw nut 210 acts on a stop 220 inside the actuation piston 202, which is arranged at longitudinal end of the actuation piston 202 directed toward the braking assembly 204, the ball screw nut moves the actuation piston 202 in the direction of the braking assembly 204, here in the direction of one of the brake pads 206. The actuation piston 202 is freely displaceable opposite the ball screw nut 210 in an actuation direction R, which runs parallel to the longitudinal extent of the spindle 216.

In the inner cavity 214, a spring element 222 compressible in the actuation direction R is received between an axial end face 224 of the ball screw nut 210 and the stop 220. On an outer side of the actuation piston 202 there is arranged a signal transmitter 226, which cooperates with a travel sensor 228, which is arranged adjacently to the signal transmitter 226, separated by a narrow air gap. The travel sensor 228 is a Hall sensor, for example. In this example, the travel sensor 228 is received in a recess in a housing 230 of the EMB system 200, in which the actuation piston 202 is also guided linearly. The signal of the travel sensor 228 is a direct measure for the displacement of the actuation piston 202 in the actuation direction R. The travel sensor 228 is connected via a plug and/or line connection 232, 234 or wireless connection to a sensor module 102 of FIG. 1, which receives the signals of the travel sensor. In some embodiments, the electric motor 218 may include a current sensor 236. The current sensor 236 detects an amount of current supplied to the electric motor 218 and provide a feedback signal to the sensor module 102.

Returning to FIG. 1, the sensor module 102 may receive the sensor data 110 from sensors of the EMB system 200. For example, the sensor data 110 includes displacement data from the travel sensor 228 and current data from the current sensor 236 of FIG. 2 for braking episodes. For example, the displacement data includes positions of the electric motor 218 based on an air gap interval between magnets of the EMB system 200. As another example, the displacement data may be the distance the one of the brake pads 206 moves toward the brake disc 208. The displacement data may also be the angular position of the electric motor 218 and the travel sensor is a Hall Effect sensor. The motor current data may be the amount of current utilized by the EMB system 200 for braking episodes. For example, the motor torque data is calculated based on current data of the amount of current applied to the electric motor 218 during the braking episode. The current data, received from the current sensor 236, for the current applied to the electric motor 218.

The sensors (e.g., the travel sensor 228, the current sensor 236) and/or the sensor module 102 are operable to sense a measurement of data associated with components of the EMB system 200 and generate a data signal for the measurement of data. These data signals can be converted into other data formats (e.g., numerical) and/or used by the sensor module 102, the computing device 104, and/or the operational system 106 to generate sensor data 110 including data metrics and parameters. The sensors can be any type of sensor, for example, force, electrical, electromechanical, optical, imaging, light, and thermal, among others. Furthermore, a single sensor may be described that includes multiple sensors and/or sensing components.

The computing device 104 includes a processor core 112, a memory 114, and a communication interface 116, which are each operably connected for computer communication via a bus 108 and/or other wired and wireless technologies. The processor core 112 processes signals and performs general computing and arithmetic functions. Signals processed by the processor may include digital signals, data signals, computer instructions, processor instructions, messages, a bit, a bit stream, that may be received, transmitted and/or detected. Generally, the processor core 112 may be a variety of various processors including multiple single and multicore processors and co-processors and other processor architectures. The processor core 112 may include logic circuitry to execute actions and/or algorithms.

The processor core 112 may also include any number of modules for performing instructions, tasks, or executables. A module includes, but is not limited to, non-transitory computer readable medium that stores instructions, instructions in execution on a machine, hardware, firmware, software in execution on a machine, and/or combinations of each to perform a function(s) or an operation(s), and/or to cause a function or operation from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

The memory 114 may include volatile memory and/or nonvolatile memory. The memory may store an operating system that controls or allocates resources of the computing device 104. The memory 114 represents a non-transitory machine-readable memory (or other medium), such as RAM, a solid-state drive, a hard disk drive or a combination thereof. The memory 114 may also be a remote data store, for example, cloud storage.

The communication interface 116 provides software and hardware to facilitate data input and output between the components of the computing device 104 and other components, networks, and data sources. The communication interface 116 may include input and/or output devices for receiving input and/or devices for outputting data. Input devices may include, for example, keyboard, microphones, pointing and selection devices, cameras, imaging devices, video cards, displays, push buttons, rotary knobs, and the like. Input devices may also include graphical input controls that take place within a user interface which may be displayed by various types of mechanisms such as software and hardware-based controls, interfaces, touch screens, touch pads or plug and play devices. An output device includes, for example, display devices, and other devices for outputting information and functions.

The computing device 104 includes a torque module 118, a coefficient module 120, and an estimation module 122. The memory 114 may store machine-readable instructions and/or operations associated with the modules 118-122. The memory 114 may store machine-readable instructions and/or operations associated with the execution module 124 of the operation system 106. For example, the torque module 118 is configured to generate a displacement-torque curve based on displacement data and motor torque data of the electric motor 218 of the EMB system 200 for a braking episode having a switchover time. The coefficient module 120 determines a high torque value and a low torque value at the switchover time from the displacement-torque curve and calculates a friction coefficient for the EMB system 200. The coefficient module 120 may also determine a non-linear coefficient from the displacement-torque curve. The estimation module 122 estimates a clamping force for a constant speed based on the friction coefficient and the non-linear coefficient. The estimation module 122 may also estimate a variable clamping force for a variable speed. The processor core 112 accesses the memory 114 and executes the machine-readable instructions as operations.

The computing device 104 is also operably connected for computer communication (e.g., via the bus 108 and/or the communication interface 116) to one or more operational systems 106. The operational system 106 can include, but is not limited to, any systems that can be used to assess, track, and/or operate the EMB system 200. For example, the execution module 124 monitors, analyzes, and/or operates the EMB system 200, to some degree, such as controlling the EMB system 200 to apply a clamping force to affect the vehicle to execute a desired amount of braking. In some embodiments, the execution module 124 may be a Proportional, Integral, Derivative (PID) controller. The implementation of the operational system 106 is dependent on the application of the clamping force estimation system 100.

In one embodiment, the memory 114 may include a neural network that may be configured to execute computer/machine based/deep learning techniques to further execute one or more algorithms to estimate clamping force. The neural network may be configured as a shallow neural network, a convolutional neural network (CNN), a Recurrent Neural Network (RNN) that includes a plurality of fully connected layers, or another type of neural network. In one embodiment, the neural network may utilize the computing device 104 to process instructions and/or operations that enable computer/machine based/deep learning that may be centered on one or more forms of input data, such an input image, that is provided to the neural network. The clamping force estimation system 100 may communicate with the neural network to send and receive data with respect to the modules 118-124.

The sensor module 102, the computing device 104, and/or the operational systems 106 are also operatively connected for computer communication to a network 126. For example, the network 126 provides software and hardware to facilitate data input and output between the computing device 104 and data sources. The network 126 is, for example, a data network, the Internet, a wide area network (WAN) or a local area (LAN) network. The network 126 serves as a communication medium to various remote devices (e.g., databases, web servers, remote servers, application servers, intermediary servers, client machines, other portable devices).

### II. Methods for Clamping Force Estimation

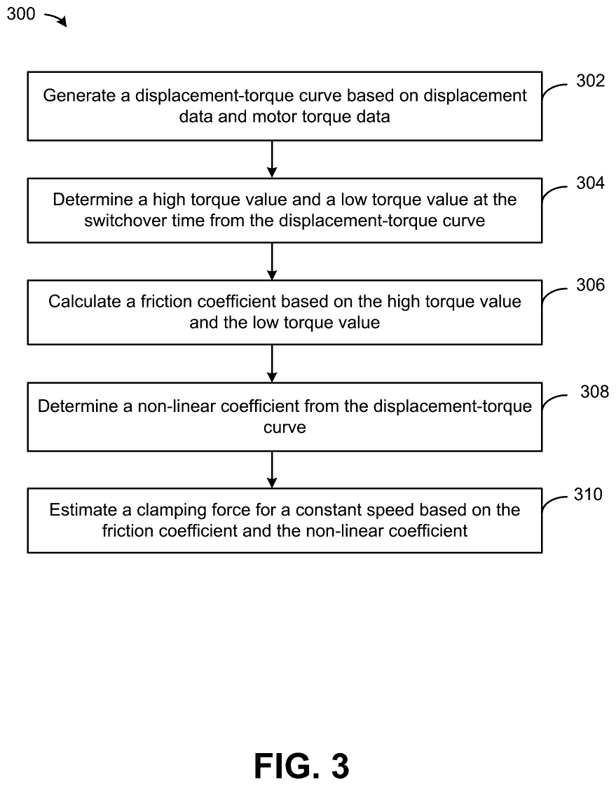

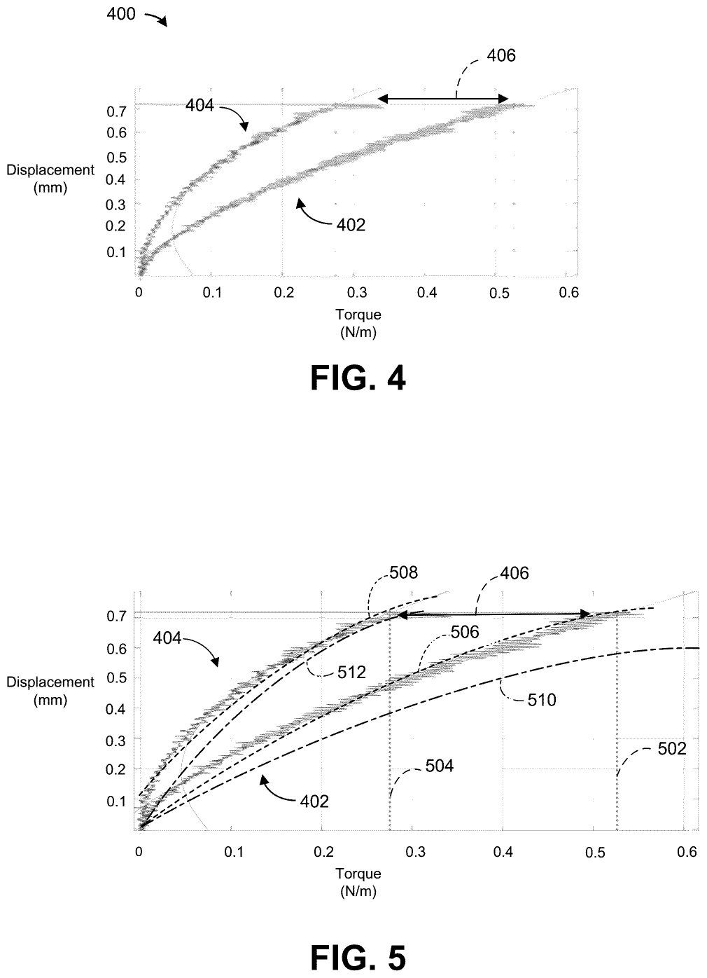

FIG. 3 illustrates a flowchart of an example method for a bond quality assessment with a bond quality assessment system. FIG. 3 will also be described with reference to FIGS. 1, 2, 4, and 5. For simplicity, the method 300 will be described as a sequence of blocks, but it is understood that the elements of the method 300 can be organized into different architectures, elements, stages, and/or processes. For purposes of simplification, FIGS. 4 and 5 employ the same reference numbers to denote the same structure.

At block 302, the method 300 includes the torque module 118 generating a displacement-torque curve based on displacement data and motor torque data of an electric motor 218 of the EMB system 200 for a braking episode having a switchover time. A braking episode includes the EMB system 200 engaging the actuation piston 202 to act on the braking assembly 204 and the EMB system 200 disengaging from the actuation piston 202. The point in time at which the EMB system 200 stops engaging the actuation piston 202 is the switchover time. The torque module 118 receives displacement data from the travel sensor 228 and current data from the current sensor 236 as the sensor data 110 from the sensor module 102. The torque module 118 generates a displacement-torque curve, such as the displacement-torque curve 400 shown in FIG. 4, that plots the displacement data versus the motor torque data.

The displacement-torque curve 400 includes a first curve 402 and a second curve 404 associated with the braking episode. The first curve 402 represents the EMB system 200 engaging the actuation piston 202 to act on the braking assembly 204, for example when the brake pedal of a vehicle is depressed. The second curve 404 represents the EMB system 200 disengaging from the actuation piston 202, for example when the brake pedal of the vehicle is released. The first curve 402 and the second curve 404 do not overlay one another due to a hysteresis characteristic 406.

The hysteresis characteristic 406 indicates that the relationship between the displacement data and the motor torque data has a non-linearity due to a fluctuation in a friction coefficient during the braking episode. The displacement data may include a displacement hysteresis. For example, when the brake pads 206 are depressed against brake disc 208 causing a deformation in the brake pads 206. Accordingly, some of force applied to the brake pads is not applied in an orthogonal direction to the brake disc 208. The displacement hysteresis describes the force loss due to the non-orthogonal application of force. Additionally, the motor torque data includes a motor torque hysteresis that describes the loss of the electric motor 218 based on a friction coefficient of the electric motor 218. The hysteresis includes the displacement hysteresis and the motor torque hysteresis. However, at the switchover time, the displacement hysteresis goes to zero since the switchover time is the time between engagement and disengagement of the EMB system 200. Accordingly, the hysteresis of the EMB system 200, described by the hysteresis characteristic 406, is given by the motor torque hysteresis alone at the switchover time, such that the motor torque hysteresis is isolated from the displacement hysteresis.

At block 304 of FIG. 3, the method 300 includes the coefficient module 120 determining a high motor torque value, τ_{H}, and a low motor torque value, τ_{L}, at the switchover time from the displacement-torque curve 400. Turning to FIG. 5, a high motor torque value τ_{H} 502 is calculated for the first curve 402 and a low motor torque value τ_{L} 504 is calculated for the second curve 404. Because the switchover time is the time between engagement and disengagement of the EMB system 200, the high motor torque value τ_{H} 502 and the low motor torque value τ_{L} 504 at the switchover time are determined at the maximum of the first curve 402 and the second curve 404, respectively.

Due to noise in the displacement data and the motor torque data of the sensor data 110, the first curve 402 and the second curve 404 are noisy. Accordingly, the coefficient module 120 may perform real-time curve fitting for higher torque values of the displacement-torque curve 400 and for lower torque values of the displacement-torque curve 400. For example, as shown in FIG. 5, a first high region curve 506 is fitted to the first curve 402 and a second high region curve 508 is fitted to the second curve 404. Likewise, a first low region curve 510 is fitted to the first curve 402 and a second low region curve 512 is fitted to the second curve 404. Because the curve fitting is performed in real-time, phase delay is not introduced to the high motor torque value τ_{H} 502 and the low motor torque value τ_{L} 504.

At block 306 of FIG. 3, the method 300 includes the coefficient module 120 calculating a friction coefficient, a, based on the high motor torque value τ_{H} 502 and the low motor torque value τ_{L} 504. The friction coefficient a indicates the unit efficiency of the EMB system 200. Because the hysteresis characteristic 406 is given by the motor torque hysteresis, the friction coefficient a is calculated from the high motor torque value τ_{H} 502 and the low motor torque value τ_{L} 504 as:

$$a = \frac{{τ}_{H} - {τ}_{L}}{{τ}_{H} + {τ}_{L}}$$

At block 308 of FIG. 3, the method 300 includes the coefficient module 120 determining a non-linear coefficient from the displacement-torque curve 400. As motor torque of the electric motor 218 increases force is applied but in a non-linear manner based on a number of non-linearity parameters. A non-linearity parameter may be misalignment of components of the EMB system 200. For example, when the EMB system 200 is engaged, the actuator piston 202 may not travel in an actuation direction R that runs parallel to the longitudinal extent of the spindle 216. The more torque that is applied by the electric motor 218, the more the actuator piston 202 may deviate from the actuation direction R such that force is increasingly diverted at angles away from the actuation direction R.

The non-linear coefficient describes non-linearity parameters, such as the loss of force based on misalignment. The coefficient module 120 may determine a non-linear coefficient from a curving differential before and/or after a threshold amount of time from the switchover time of the first curve 402 and the second curve 404. For example, if when approaching a maximum force, the first curve 402 and/or the second curve 404 exhibit bending indicative of non-linearity, the slope of the bend may be used to determine the non-linear coefficient.

In some embodiments, the non-linear coefficient is based on a plurality of braking episodes. In a similar manner as described above with respect to block 304 of the method 300, the coefficient module 120 may determine a first high motor torque value, τ_{H1}, and a first low motor torque value, τ_{L1}, at a first switchover time from a first displacement-torque curve of a first braking episode. The coefficient module 120 may also determine a second high motor torque value, τ_{H2}, and a first low motor torque value, τ_{L2}, at a second switchover time from a second displacement-torque curve of a second braking episode. The coefficient module 120 may then determine the non-linear coefficient based on the motor torque values of first switchover time and the second switchover time. While described with respect to two braking episodes, any number of braking episodes may be used.

The non-linear coefficient may be based on whether force is being estimated for the EMB system 200 being engaged, for example, by depressing a brake pedal of the vehicle or the EMB system 200 being disengaged, for example, by releasing the brake pedal. If the EMB system 200 is being engaged, such that:

$$\frac{{e}^{{τ}_{H 2}}}{1 + a} > \frac{{e}^{{τ}_{L 2}}}{1 - a}$$

Then the coefficient module 120 calculates an engagement non-linear coefficient, b, using the equality:

$$\frac{{e}^{{τ}_{H 2}} - {b ( {τ}_{H 2} - {τ}_{H 1} )}^{1.25}}{1 + a} = \frac{{e}^{{τ}_{L 2}}}{1 - a}$$

Similarly, if the EMB system 200 is being disengaged, such that:

$$\frac{{e}^{{τ}_{H 2}}}{1 + a} < \frac{{e}^{{τ}_{L 2}}}{1 - a}$$

Then the coefficient module 120 calculates a disengagement non-linear coefficient, c, using the equality:

$$\frac{{e}^{{τ}_{L 2}}}{1 + a} = \frac{{e}^{{τ}_{L 2}} + {c ( {τ}_{L 2} - {τ}_{L 1} )}^{1.25}}{1 - a}$$

Because the non-linear coefficient may be calculated based on the status of the EMB system 200 as being engaged or disengaged, only one non-linear coefficient is calculated. For example, when the EMB system 200 is engaged, the engagement non-linear coefficient, b, is determined, because the disengagement non-linear coefficient, c, is zero. Likewise, when the EMB system 200 is disengaged, the disengagement non-linear coefficient, c, is determined, because the engagement non-linear coefficient, b, is zero.

At block 310 of FIG. 3, the method 300 includes the estimation module 122 estimating a clamping force based on the friction coefficient a and a non-linear coefficient, such as the engagement non-linear coefficient, b, or the disengagement non-linear coefficient, c. In particular, the clamping force being applied by the EMB system 200 for a given motor torque value at speed, τₘₒₜₒᵣ(s), according to:

$${F}_{clamp} ( s ) = \{ \begin{matrix}\{ \begin{matrix}\frac{{e}^{{τ}_{motor}} ( s )}{1 + a} , & {τ}_{motor} < {τ}_{H 1} & \\ & & if \dot{s} > 0 \\ \frac{{e}^{{τ}_{motor} ( s )} - {b ( {τ}_{motor} - {τ}_{H 1} )}^{1.25}}{1 + a} , & {τ}_{motor} \geq {τ}_{H 1} & \end{matrix} \\ \{ \begin{matrix}\frac{{e}^{{τ}_{motor}} ( s )}{1 - a} , & {τ}_{motor} < {τ}_{L 1} & \\ & & if \dot{s} < 0 \\ \frac{{e}^{{τ}_{motor} ( s )} + {c ( {τ}_{motor} - {τ}_{L 1} )}^{1.25}}{1 - a} , & {τ}_{motor} \geq {τ}_{L 1} & \end{matrix}\end{matrix}$$

Thus, the clamping force is estimated based on the friction coefficient that is tailored to the efficiency of the hardware of the EMB system 200 at speed and a non-linear coefficient without adding additional components, such as a force sensor, to the EMB system 200. The clamping force may be estimated for a vehicle in operation to facilitate operation, safety, or the functionality of the EMB system 200. In another embodiment, the clamping force is estimated for tracking or assessment of the EMB system 200 or hardware components of the EMB system 200. For example, the EMB system may be tracked over the lifetime of the vehicle to assess the impacts of wear, use, and/or age.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

A “value” as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value of X may be given as a percentage between 0% and 100%. In other cases, the value of X could be a value in the range between 1 and 10. In still other cases, the value of X may not be a numerical value, but could be associated with a given discrete state, such as “not X”, “slightly x”, “x”, “very x” and “extremely x”.

In this description, unless otherwise stated, “about,” “approximately” or “substantially” preceding a parameter means being within +/−10 percent of that parameter. Modifications are possible in the described embodiments, and other embodiments are possible, within the scope of the claims.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A non-transitory machine-readable medium having machine executable instructions for clamping force estimation of an electromechanical brake (EMB) system causing a processor core to execute operations, the operations comprising:
generating a displacement-torque curve based on displacement data and motor torque data of an electric motor of the EMB system for a braking episode having a switchover time;
determining a high torque value and a low torque value at the switchover time from the displacement-torque curve;
calculating a friction coefficient based on the high torque value and the low torque value;
determining a non-linear coefficient from the displacement-torque curve; and
estimating a clamping force for a constant speed based on the friction coefficient and the non-linear coefficient.

2. The non-transitory machine-readable medium of claim 1, wherein the displacement data includes displacement hysteresis, and the motor torque data includes motor torque hysteresis, and wherein the displacement hysteresis goes to zero at the switchover time.

3. The non-transitory machine-readable medium of claim 1, wherein the displacement data includes positions of the electric motor based on an air gap interval between magnets of the EMB system.

4. The non-transitory machine-readable medium of claim 1, wherein the motor torque data is calculated based on current data of current applied to the electric motor during the braking episode.

5. The non-transitory machine-readable medium of claim 4, further comprising:
receiving the current data, from a current sensor, for the current applied to the electric motor.

6. The non-transitory machine-readable medium of claim 1, wherein determining the high torque value and the low torque value includes performing real-time curve fitting for higher torque values of the displacement-torque curve and for lower torque values of the displacement-torque curve.

7. The non-transitory machine-readable medium of claim 1, wherein the friction coefficient indicates unit efficiency of the EMB system.

8. The non-transitory machine-readable medium of claim 1, wherein the switchover time is a first switchover time, and the braking episode is a first braking episode, and wherein the non-linear coefficient is determined based on the first switchover time and a second switchover time of a second braking episode.

9. A clamping force estimation system for an EMB system, the clamping force estimation system comprising:
a memory for storing machine-readable instructions; and
a processor core for accessing the machine-readable instructions and executing the machine-readable instructions as operations, the operations comprising:
generating a displacement-torque curve based on displacement data and motor torque data of an electric motor of the EMB system for a braking episode having a switchover time;
determining a high torque value and a low torque value at the switchover time from the displacement-torque curve;
calculating a friction coefficient based on the high torque value and the low torque value;
determining a non-linear coefficient from the displacement-torque curve; and
estimating a clamping force for a constant speed based on the friction coefficient and the non-linear coefficient.

10. The clamping force estimation system of claim 9, wherein the friction coefficient indicates unit efficiency of the EMB system.

11. The clamping force estimation system of claim 9, wherein the displacement data includes displacement hysteresis, and the motor torque data includes motor torque hysteresis, and wherein the displacement hysteresis goes to zero at the switchover time.

12. The clamping force estimation system of claim 9, wherein the displacement data includes positions of the electric motor based on an air gap interval between magnets of the EMB system, and wherein the motor torque data is calculated based on currents applied to the electric motor during the braking episode.

13. The clamping force estimation system of claim 9, wherein the switchover time is a first switchover time, and the braking episode is a first braking episode, and wherein the non-linear coefficient is determined based on the first switchover time and a second switchover time of a second braking episode.

14. The clamping force estimation system of claim 9, wherein determining the high torque value and the low torque value includes performing real-time curve fitting for higher torque values of the displacement-torque curve and for lower torque values of the displacement-torque curve.

15. A method for clamping force estimation for an EMB system, the clamping force estimation method comprising:
generating a displacement-torque curve based on displacement data and motor torque data of an electric motor of the EMB system for a braking episode having a switchover time;
determining a high torque value and a low torque value at the switchover time from the displacement-torque curve;
calculating a friction coefficient based on the high torque value and the low torque value;
determining a non-linear coefficient from the displacement-torque curve; and
estimating a clamping force for a constant speed based on the friction coefficient and the non-linear coefficient.

16. The clamping force estimation method of claim 15, wherein determining the high torque value and the low torque value includes performing real-time curve fitting for higher torque values of the displacement-torque curve and for lower torque values of the displacement-torque curve.

17. The clamping force estimation method of claim 15, wherein the friction coefficient indicates unit efficiency of the EMB system.

18. The clamping force estimation method of claim 15, wherein the switchover time is a first switchover time, and the braking episode is a first braking episode, and wherein the non-linear coefficient is determined based on the first switchover time and a second switchover time of a second braking episode.

19. The clamping force estimation method of claim 15, wherein the motor torque data is calculated based on current data of current applied to the electric motor during the braking episode.

20. The clamping force estimation method of claim 19, further comprising:
receiving the current data, from a current sensor, for the current applied to the electric motor.
